(19) United States
(12) Patent Application Publication
(10) Pub. No.: US 2022/0101025 A1
(43) Pub. Date: Mar. 31, 2022

(54) TEMPORARY STOP DETECTION DEVICE, TEMPORARY STOP DETECTION SYSTEM, AND RECORDING MEDIUM

(71) Applicant: TOYOTA JIDOSHA KABUSHIKI KAISHA, Toyota-shi (JP)

(72) Inventors: Kenki Ueda, Tokyo-to (JP); Ryosuke Tachibana, Tokyo-to (JP); Shinichiro Kawabata, Tokyo-to (JP); Takashi Kitagawa, Kodaira-shi (JP); Takanori Kato, Kawasaki-shi (JP); Hidetoshi Nitta, Yokohama-shi (JP); Kohei Harayama, Kawasaki-shi (JP); Mizuki Mori, Tokyo-to (JP)

(73) Assignee: TOYOTA JIDOSHA KABUSHIKI KAISHA, Toyota-shi (JP)

(21) Appl. No.: 17/394,477

(22) Filed: Aug. 5, 2021

(30) Foreign Application Priority Data
Sep. 29, 2020 (JP) 2020-164004

(51) Int. Cl. G06K 9/00; G06K 9/32; B60W 40/02; B60W 40/105

(52) U.S. Cl. CPC G06K 9/00818; G06K 9/3233; B60W 2555/60; B60W 40/105; B60W 40/02

(57) ABSTRACT

A temporary stop detection device that includes: a memory; and a processor coupled to the memory, the processor being configured to: acquire image information indicating a captured image captured by an imaging device provided to a vehicle; detect a plurality of road signs, including a temporary stop sign, from the acquired image information; and detect a temporary stop position by using a bounding box surrounding a region including the plurality of detected road signs.

### CROSS-REFERENCE TO RELATED APPLICATION

This application is based on and claims priority under 35 USC 119 from Japanese Patent Application No. 2020-164004 filed on Sep. 29, 2020, the disclosure of which is incorporated by reference herein.

### BACKGROUND

### Technical Field

The present disclosure relates to a temporary stop detection device, a temporary stop detection system, and a non-transitory computer-readable recording medium recorded with a temporary stop detection program for detecting a temporary stop of a vehicle from a captured image captured from a vehicle.

### Related Art

Japanese Patent Application Laid-Open (JP-A) No. 2007-052645 discloses a road marking recognition method including a process of acquiring image data of a road surface, a process of detecting a first road marking in the image data and storing its position data in a storage device, and a process of detecting a second road marking in the image data and storing its position data in the storage device. The road marking recognition method also includes a positional relationship determination process of determining based on the position data stored in the storage device whether or not the first road marking and the second road marking satisfy a predefined normal mutual positional relationship, and a process of evaluating a confidence level of the first road marking and the second road marking using a determination result from the positional relationship determination process.

In JP-A No. 2007-052645, although a confidence level is computed based on the positional relationship of a pedestrian crossing or a stop line in road marking recognition, a temporary stop line may be difficult to detect in some cases. For example, when detecting a temporary stop position, a stop line or pedestrian crossing may be hidden by a vehicle traveling ahead, or detection of the stop position may be difficult due to paint that has peeled away due to age. There is therefore room for improvement with regard to detection of a missed temporary stop at a temporary stop position.

### SUMMARY

An aspect of the present disclosure is a temporary stop detection device that includes: a memory; and a processor coupled to the memory, the processor being configured to: acquire image information indicating a captured image captured by an imaging device provided to a vehicle; detect a plurality of road signs, including a temporary stop sign, from the acquired image information; and detect a temporary stop position by using a bounding box surrounding a region including the plurality of detected road signs.

### BRIEF DESCRIPTION OF DRAWINGS

FIG. 1 is a diagram illustrating a schematic configuration of a dangerous driving detection system according to an exemplary embodiment;

FIG. 2 is a functional block diagram illustrating functional configurations of an onboard device and a dangerous driving data gathering server in a dangerous driving detection system according to an exemplary embodiment;

FIG. 3 is a block diagram illustrating configuration of an onboard device and a dangerous driving data gathering server;

FIG. 4 is a block diagram illustrating a functional configuration of a dangerous driving detection section;

FIG. 5 is a diagram illustrating an example of a bounding box surrounding a region including plural road signs and object bounding boxes surrounding individual objects;

FIG. 6 is a diagram illustrating state transitions during detection of a missed temporary stop by a missed temporary stop detection section; and

FIG. 7 is a flowchart illustrating an example of a flow of processing performed by a control section of an onboard device in a dangerous driving detection system according to an exemplary embodiment.

### DETAILED DESCRIPTION

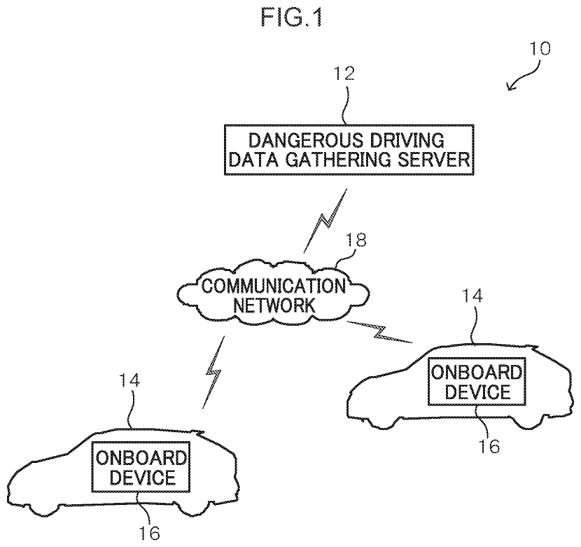

Detailed explanation follows regarding an example of an exemplary embodiment of the present disclosure, with reference to the drawings. In the present exemplary embodiment, a dangerous driving detection system is described as an example of a temporary stop detection system. FIG. 1 is a diagram illustrating a schematic configuration of the dangerous driving detection system according to the present exemplary embodiment.

In a dangerous driving detection system 10 according to the present exemplary embodiment, onboard devices 16, each serving as an example of a temporary stop detection device installed in a vehicle 14, are connected to a dangerous driving data gathering server 12 over a communication network 18. In the dangerous driving detection system 10 according to the present exemplary embodiment, image information captured by the plural onboard devices 16 and vehicle information expressing states of the respective vehicles 14 are transmitted to the dangerous driving data gathering server 12, and the dangerous driving data gathering server 12 collects this image information and vehicle information. The dangerous driving data gathering server 12 also performs driver evaluation processing and the like based on the collected image information and vehicle information.

Each of the onboard devices 16 of the present exemplary embodiment performs processing to detect dangerous driving by an occupant, and dangerous driving detection results are transmitted to the dangerous driving data gathering server 12. In the present exemplary embodiment, explanation follows regarding an example in which a missed temporary stop at a temporary stop position is detected as an example of dangerous driving detected by the onboard device 16.

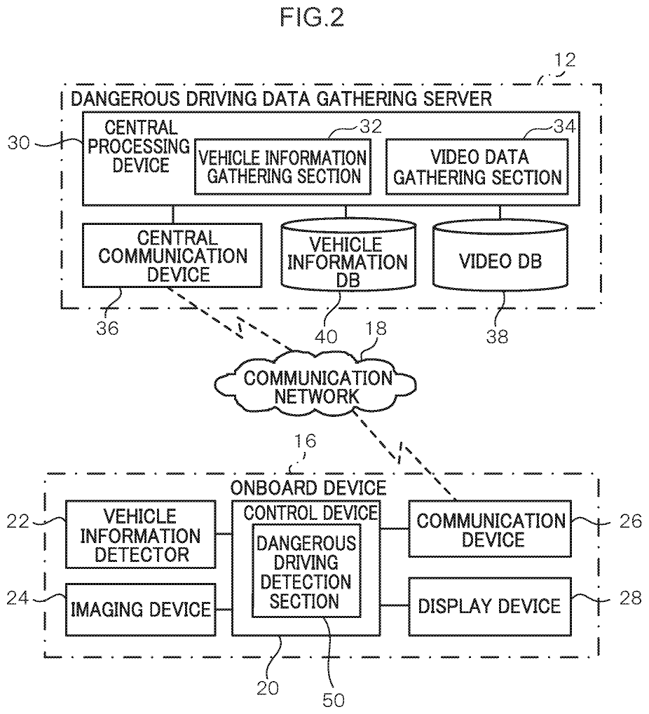

FIG. 2 is a functional block diagram illustrating functional configurations of the onboard device 16 and the dangerous driving data gathering server 12 of the dangerous driving detection system 10 according to the present exemplary embodiment.

Each of the onboard devices 16 includes a control device 20, a vehicle information detector 22, an imaging device 24, a communication device 26, and a display device 28.

The vehicle information detector 22 detects vehicle information relating to the corresponding vehicle 14. Examples of the vehicle information detected include position information, a vehicle speed, acceleration, steering angle, accelerator pedal position, distances to obstacles in the vehicle surroundings, a route, and so on of the vehicle 14. More precisely, plural types of sensors and other devices may be applied as the vehicle information detector 22 in order to acquire information expressing a situation in the surrounding environment of the vehicle 14. Examples of such sensors and other devices include sensors such as a vehicle speed sensor and an acceleration sensor installed in the vehicle 14, a global navigation satellite system (GNSS) device, an onboard transceiver, a navigation system, and a radar device. The GNSS device measures the position of the ego vehicle 14 by receiving GNSS signals from plural GNSS satellites. The precision of the positioning by such a GNSS device improves the greater the number of GNSS signals that can be received. The onboard transceiver is a communication device that performs at least one out of vehicle-to-vehicle communication with other vehicles 14 or roadside-to-vehicle communication with roadside equipment via the communication device 26. The navigation system includes a map information storage section stored with map information, and performs processing to display the position of the ego vehicle 14 on a map and provide guidance along a route to a destination based on position information acquired from a GNSS device and the map information stored in the map information storage section. The radar device includes plural radars with different detection ranges, and detects objects such as pedestrians and other vehicles 14 present in the surroundings of the ego vehicle 14, and acquires relative positions and relative speeds of such detected objects with respect to the ego vehicle 14. Such a radar device includes an inbuilt processor to process scan results for such surrounding objects. The processor eliminates noise and roadside objects such as guardrails from monitoring targets based on changes in the relative positions and relative speeds of individual objects included in plural recent scan results, and tracks and monitors pedestrians, other vehicles 14, and the like as monitoring targets. The radar device also outputs information such as the relative positions and relative speeds of the individual monitoring target objects. Note that in the present exemplary embodiment, at least the vehicle speed is detected as vehicle information.

In the present exemplary embodiment, the imaging device 24 is installed in the corresponding vehicle 14 so as to image the vehicle surroundings, for example in front of the vehicle 14, and to generate video image data expressing a captured video image. The imaging device 24 may be an imager, for example, a camera such as a drive recorder. Note that the imaging device 24 may also image the vehicle surroundings at at least one out of the sides or rear of the vehicle 14. The imaging device 24 may also image a vehicle cabin interior.

The communication device 26 establishes communication with the dangerous driving data gathering server 12 over the communication network 18, and transmits and receives information such as image information captured by the imaging device 24 and vehicle information detected by the vehicle information detector 22.

The display device 28 displays information in order to present various information to an occupant. In the present exemplary embodiment, the display device 28 may, for example, display information provided by the dangerous driving data gathering server 12.

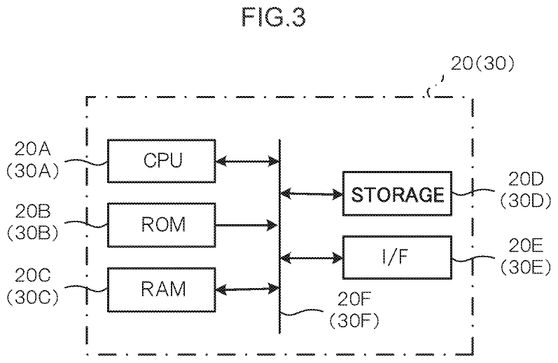

As illustrated in FIG. 3, the control device 20 is configured by a microcomputer including a central processing unit (CPU) 20A, serving as an example of a hardware processor, read only memory (ROM) 20B, serving as an example of memory, random access memory (RAM) 20C, storage 20D, an interface (I/F) 20E, and a bus 20F. A GPU may be employed instead of the CPU.

The CPU 20A of the control device 20 uses the RAM 20C to load and execute a program held in the ROM 20B in order to implement the functionality of a dangerous driving detection section 50 (described in detail later). The control device 20 also performs control to upload image information of a video image expressing images captured by the imaging device 24, and vehicle information detected by the vehicle information detector 22 at the time of this imaging, to the dangerous driving data gathering server 12. Note that when uploading the image information and the vehicle information, identification information to identify an individual vehicle and an individual driver is appended before transmitting. For example, this driver identification information may be a captured image of the driver, identification information for a smart key carried by the driver, or other information that enables identification of the driver. The program may be recorded on a non-transitory computer readable recording medium such as a HDD, SSD, or DVD and loaded by the CPU 20A using the RAM 20C.

The dangerous driving data gathering server 12 includes a central processing device 30, a central communication device 36, a vehicle information database (DB) 40, and a video DB 38.

As illustrated in FIG. 3, the central processing device 30 is a microcomputer including a CPU 30A, ROM 30B, RAM 30C, storage 30D, an interface (I/F) 30E, a bus 30F, and the like.

The CPU 30A of the central processing device 30 loads and executes a program held in the ROM 30B using the RAM 30C in order to implement the functionality of a vehicle information gathering section 32 and a video data gathering section 34. The program may be recorded on a non-transitory computer readable recording medium such as a HDD, SSD, or DVD and loaded by the CPU 30A using the RAM 30C.

The vehicle information gathering section 32 gathers vehicle information detected by the respective onboard devices 16 of the plural vehicles 14, and performs processing to collect this vehicle information in the vehicle information DB 40.

The video data gathering section 34 gathers video image data captured by the respective onboard devices 16 of the plural vehicles 14 as image information, and performs processing to collect this image information in the video DB 38.

The central communication device 36 establishes communication with the onboard devices 16 over the communication network 18, and transmits and receives information such as the image information and vehicle information.

The vehicle information DB 40 collects the vehicle information gathered by the vehicle information gathering section 32 in association with identification information to identify each of the vehicles and each of the drivers.

The video DB 38 collects the video image data gathered by the video data gathering section 34 in association with the identification information to identify each of the vehicles and each of the drivers.

The dangerous driving data gathering server 12 performs processing to detect dangerous driving based on the vehicle information and video image data collected in the vehicle information DB 40 and the video DB 38, processing to evaluate drivers based on the dangerous driving detection results, and the like. The dangerous driving data gathering server 12 then provides various services, such as services to feedback dangerous driving detection results and driving evaluation results to the drivers.

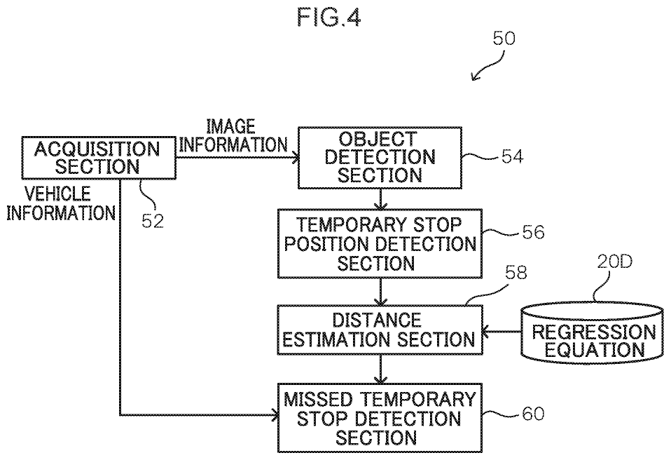

Next, detailed explanation follows regarding functional configuration of the dangerous driving detection section 50 of the control device 20 of the onboard device 16, described above. FIG. 4 is a block diagram illustrating the functional configuration of the dangerous driving detection section 50.

As illustrated in FIG. 4, the dangerous driving detection section 50 includes the functionality of an acquisition section 52, an object detection section 54, serving as an example of a detection section, a temporary stop position detection section 56, serving as an example of a stop position detection section, a distance estimation section 58, serving as an estimation section, and a missed temporary stop detection section 60, serving as an example of a stop detection section.

The acquisition section 52 acquires the video image data, serving as image information expressing a captured image of a video image captured by the imaging device 24 installed in the corresponding vehicle 14, and also acquires the vehicle information detected by the vehicle information detection section 22. The acquisition section 52 also performs timing alignment on the video image data and the vehicle information as pre-processing to synchronize the video image data with the vehicle information.

The object detection section 54 employs known object detection processing to detect road signs corresponding to signposts, pedestrian crossings, traffic signals, stop lines, and so on in the images.

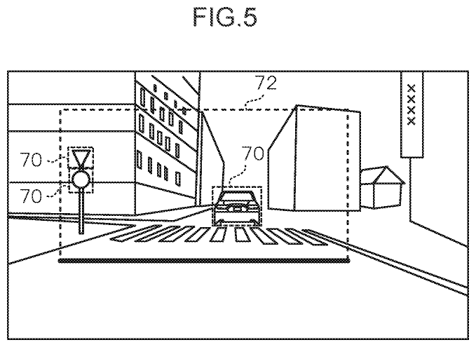

The temporary stop position detection section 56 detects a temporary stop position by employing a bounding box surrounding a region including plural road signs detected by the object detection section 54. More precisely, a trained model that has learned a temporary stop position as an image region including plural road signs is employed in order to generate a bounding box 72 surrounding a region including plural road signs as illustrated in FIG. 5, and to detect the position of a base edge of the bounding box 72 as a temporary stop position. Detecting a temporary stop position by employing the trained model that has learned a temporary stop position as an image region including plural road signs in this manner enables a temporary stop position to be detected by multidimensional determination based on plural road signs. Note that in addition to the bounding box 72 surrounding a region including plural road signs, bounding boxes 70 surrounding individual objects (for example the signposts and vehicle 14 in FIG. 5) may also be generated during object detection by the object detection section 54. When training the trained model, images of regions including temporary stop lines, pedestrian crossings, signposts, and the like are learned as annotations.

The distance estimation section 58 estimates a distance from an ego vehicle to a temporary stop position based on the images captured by the imaging device 24. For example, positional coordinates of the base edge of the above-described bounding box 70 or bounding box 72 and a data set of correct solution values for distances from the vehicle are employed to pre-derive a regression equation to estimate the distance of a target from the positional coordinates of the base edge. The regression equation is then used to estimate the distance from an imaging position of the imaging device to the temporary stop position, using the positional coordinates of the base edge as an input. Note that the pre-derived regression equation is pre-stored in the storage 20D.

The missed temporary stop detection section 60 detects for passage of a temporary stop position in order to detect a missed temporary stop at the temporary stop position. In the present exemplary embodiment, a temporary stop line is determined to have been passed in cases in which a distance to a temporary stop position has come within a predetermined first distance and a temporary stop sign has been detected, and a distance to the temporary stop position then comes within a second distance that is shorter than the first distance. A missed temporary stop is detected in cases in which the vehicle speed is a predetermined speed or greater when the distance to the temporary stop position is within the first distance. More precisely, in a case in which a temporary stop sign is detected within 10 m of the temporary stop position, and the distance to the temporary stop position then comes within 3 m, the temporary stop line is determined to have been passed. If a minimum speed is 10 km/h or greater when within 10 m of the temporary stop position, a missed temporary stop is detected. Although the following explanation concerns an example in which the first distance is 10 m, the second distance is 3 m, and the predetermined speed is 10 km/h, there is no limitation thereto. For example, the distances may vary accordingly to the length of a front section of the vehicle 14 or the like. Alternatively, at least one out of distance or speed may be set differently according to the vehicle type. Alternatively, at least one out of distance or speed may be settable for each driver. This enables missed temporary stops to be detected according to least one out of by user sensation or by characteristics of individual vehicle type.

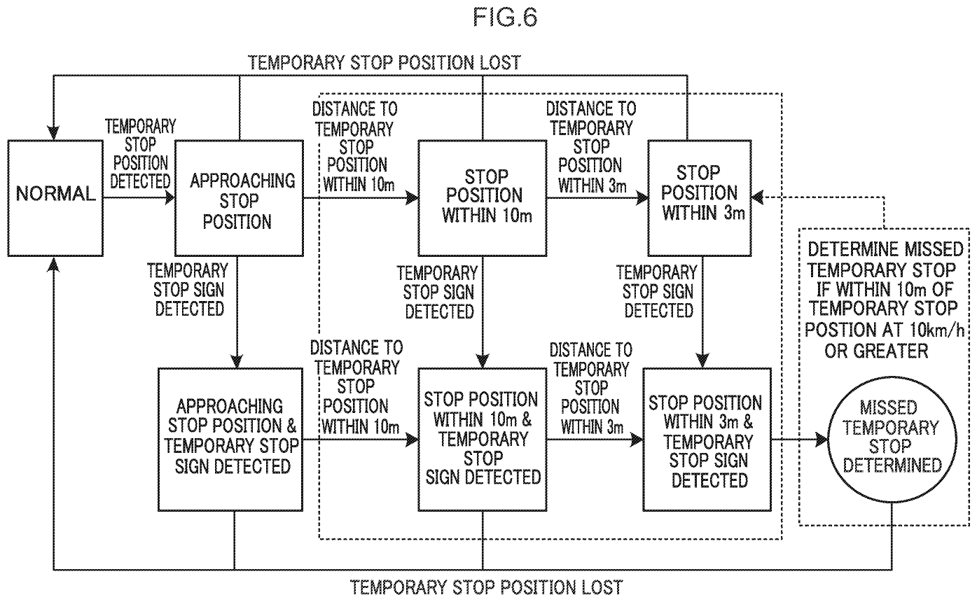

Explanation follows regarding an example of a missed temporary stop detection method by the missed temporary stop detection section 60, with reference to FIG. 6. FIG. 6 illustrates an example of a diagram illustrating state transitions during detection of a missed temporary stop by the missed temporary stop detection section 60.

First, when the temporary stop position detection section 56 detects a temporary stop position, a “normal” state transitions to an “approaching stop position” state.

When the distance to the temporary stop position comes within 10 m, the “approaching stop position” state transitions to a “stop position within 10 m” state.

When the distance to the temporary stop position comes within 3 m, the “stop position within 10 m” state transitions to a “stop position within 3 m” state.

On the other hand, when a temporary stop sign is detected by the object detection section 54 when in the “approaching stop position” state, the state transitions to a “approaching stop position and temporary stop sign detected” state. Similarly, when a temporary stop sign is detected by the object detection section 54 when in the “stop position within 10 m” state, the state transitions to a “stop position within 10 m & temporary stop sign detected” state. Similarly, when a temporary stop sign is detected by the object detection section 54 when in the “stop position within 3 m” state, the state transitions to a “stop position within 3 m & temporary stop sign detected” state.

If the temporary stop position is no longer detected (is lost) by the temporary stop position detection section 56 when in any out of the “approaching stop position”, “stop position within 10 m”, or “stop position within 3 m” states, the state transitions to the “normal” state.

When the distance to the temporary stop position comes within 10 m when in the “approaching stop position & temporary stop sign detected” state, the state transitions to the “stop position within 10 m & temporary stop sign detected” state.

When the distance to the temporary stop position comes within 3 m when in the “stop position within 10 m & temporary stop sign detected” state, the state transitions to the “stop position within 3 m & temporary stop sign detected” state.

When the temporary stop position is no longer detected (is lost) by the temporary stop position detection section 56 when in either the “approaching stop position & temporary stop sign detected” state or the “stop position within 10 m & temporary stop sign detected” state, the state transitions to the “normal” state.

In the present exemplary embodiment, in cases in which the temporary stop position is within 10 m and a temporary stop sign has been detected, the temporary stop line is determined to have been passed after coming within 3 m of the temporary stop position. Note that in cases in which the minimum speed is 10 km/h or greater when the temporary stop position is within 10 m, the missed temporary stop detection section 60 determines and detects a missed temporary stop.

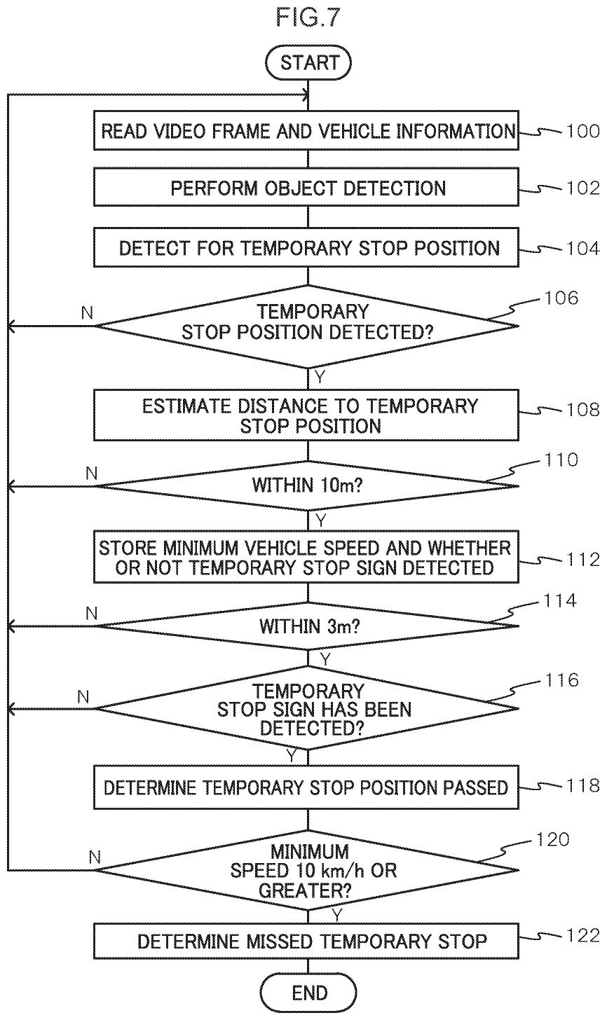

Next, explanation follows regarding processing performed by the control device 20 of the onboard device 16 in the dangerous driving detection system 10 according to the present exemplary embodiment configured as described above. FIG. 7 is a flowchart illustrating an example of a flow of processing performed by the control device 20 of the onboard device 16 in the dangerous driving detection system 10 according to the present exemplary embodiment. Note that the processing in FIG. 7 is, for example, started when an ignition switch has been switched on.

At step 100, the CPU 20A reads a video frame and vehicle information, and processing transitions to step 102. Namely, the acquisition section 52 acquires a video frame of the video image data expressing a captured image in the video image captured by the imaging device 24 installed in the corresponding vehicle 14, and also acquires the vehicle information detected by the vehicle information detector 22.

At step 102, the CPU 20A performs object detection in the video frame, and processing transitions to step 104. Namely, the object detection section 54 employs known object detection processing to detect road signs corresponding to signposts, pedestrian crossings, traffic signals, stop lines, and so on in the image.

At step 104, the CPU 20A detects for a temporary stop position in the video frame, and processing transitions to step 106. Namely, the temporary stop position detection section 56 employs a bounding box 72 surrounding a region including plural road signs detected by the object detection section 54 to detect for a temporary stop position. In the present exemplary embodiment, a trained model that has learned a temporary stop position as an image region including plural road signs is employed to generate a bounding box 72 surrounding a region including plural road signs as illustrated in FIG. 5, and to detect the position of the base edge of the bounding box 72 as a temporary stop position. This enables the temporary stop position to be detected even in cases in which a stop line is hidden by a vehicle ahead or the like, or if the paint of the stop line has peeled away due to age, and so on.

At step 106, the CPU 20A determines whether or not a temporary stop position has been detected. Processing returns to step 100 and the above processing is repeated in cases in which determination is negative, and processing transitions to step 108 in cases in which determination is affirmative.

At step 108, the CPU 20A estimates the distance to the temporary stop position, and processing transitions to step 110. Namely, the distance estimation section 58 estimates the distance from the ego vehicle to the temporary stop position based on an image captured by the imaging device 24. In the present exemplary embodiment, positional coordinates of the base edge of the above-described bounding box 70 or bounding box 72 and a data set of correct solution values for distances from the vehicle are employed to pre-derive a regression equation to estimate the distance of a target from the positional coordinates of the base edge. The regression equation is then used to estimate the distance from an imaging position of the imaging device to the temporary stop position, using the positional coordinates of the base edge as an input. This enables the distance to the temporary stop position to be estimated from the captured image, even in cases in which a stop line is hidden by a vehicle ahead or the like, or if the paint of the stop line has peeled away due to age, and so on.

At step 110, the CPU 20A determines whether or not the distance to the temporary stop position is within 10 m. As this determination, the missed temporary stop detection section 60 determines whether or not the distance to the temporary stop position as estimated by the distance estimation section 58 is within 10 m. Processing returns to step 100 and the above-described processing is repeated in cases in which determination is negative, and processing transitions to step 112 in cases in which determination is affirmative. Note that this determination may for example consider plural past frames (for example by computing an average or the like) when determining whether or not the distance to the temporary stop position is within 10 m in order to prevent determination from fluctuating on a frame-by-frame basis.

At step 112, the CPU 20A stores a minimum speed and whether or not a temporary stop sign has been detected, and processing transitions to step 114.

At step 114, the CPU 20A determines whether or not the distance to the temporary stop position is within 3 m. As this determination, the missed temporary stop detection section 60 determines whether or not the distance to the temporary stop position as estimated by the distance estimation section 58 is within 3 m. Processing returns to step 100 and the above-described processing is repeated in cases in which determination is negative, and processing transitions to step 116 in cases in which determination is affirmative. Note that this determination may for example consider plural past frames (for example by computing an average or the like) when determining whether or not the distance to the temporary stop position is within 3 m in order to prevent determination from fluctuating on a frame-by-frame basis.

At step 116, the CPU 20A determines whether or not a temporary stop sign has been detected. As this determination, the missed temporary stop detection section 60 determines whether or not detection of a temporary stop sign has been stored at step 112 described above. Processing returns to step 100 and the above-described processing is repeated in cases in which determination is negative, and processing transitions to step 118 in cases in which determination is affirmative.

At step 118, the CPU 20A determines that the temporary stop position has been passed, and processing transitions to step 120. Namely, the missed temporary stop detection section 60 determines that the temporary stop line has been passed and thus detects that the temporary stop position has been passed in cases in which a temporary stop sign has been detected when within 10 m of the temporary stop position, and an approach is then within 3 m of the temporary stop position.

At step 120, determination is made as to whether or not the minimum speed when the distance to the temporary stop is within 10 m is 10 km/h or greater. As this determination, the missed temporary stop detection section 60 determines whether or not the minimum speed stored at step 112 is 10 km/h or greater. Processing returns to step 100 and the above-described processing is repeated in cases in which determination is negative, and processing transitions to step 122 in cases in which determination is affirmative.

At step 122, the CPU 20A determines a missed temporary stop, and the processing routine is ended. Namely, in cases in which the missed temporary stop detection section 60 determines that the temporary stop line has been passed at step 118, and the minimum speed when within 10 m of the temporary stop position is 10 km/h or greater, determination is made of a missed temporary stop at the temporary stop position.

Note that in the present exemplary embodiment, the temporary stop line is determined to have been passed in cases in which an approach is estimated to have come within the predetermined first distance of a temporary stop position, and the approach is estimated to have come within the second distance of the temporary stop position, the second distance being shorter than the first distance. Moreover, a missed temporary stop is detected in cases in which a temporary stop sign is detected when within the first distance and the vehicle is a predetermined speed or greater when within the first distance. However, detection of a missed temporary stop is not limited thereto. For example, steps 114 to 118 described above may be omitted, and a missed temporary stop may be detected in cases in which a temporary stop sign is detected when the distance to a temporary stop position is within a predetermined distance, and the vehicle speed serving as the vehicle information is a predetermined speed or greater when within the predetermined distance. Since the temporary stop position is detected from an image, the temporary stop position is hidden by the ego vehicle and no longer detected immediately prior to actually reaching the temporary stop position. Detecting the vehicle speed when the distance to the temporary stop position is within the predetermined distance in such a manner enables detection of a missed temporary stop at the temporary stop position.

Moreover, although explanation has been given in which the functionality of the dangerous driving detection section 50 corresponds to functionality of the control device 20 of the onboard device 16 in the exemplary embodiment described above, there is no limitation thereto. For example, this functionality may be provided as functionality of the central processing device 30 of the dangerous driving data gathering server 12. Alternatively, this functionality may be provided to another server connected over the communication network 18. Alternatively, this functionality may be provided in an application installed on a mobile terminal carried by an occupant.

Although a temporary stop position is detected by learning such that the position of the base of the bounding box 72 serves as a temporary stop position in the exemplary embodiment described above, there is no limitation to employing the base of the bounding box 72. For example, learning may be performed such that a predetermined position toward the image upper side from the base of the bounding box is detected as a temporary stop position. Alternatively, learning may be performed such that a central position of the bounding box 72 is detected as a temporary stop position.

Although explanation has been given regarding an example in which the processing performed by the control device 20 of the onboard device 16 is software processing performed by executing a program in the exemplary embodiment described above, there is no limitation thereto. For example, this processing may be performed by hardware such as an application specific integrated circuit (ASIC) or a field-programmable gate array (FPGA). Alternatively, the processing may be performed by a combination of both software and hardware. In cases in which processing is performed by software, such a program may be circulated in a format stored in various non-transitory computer readable recording media.

The present disclosure is not limited to the above description, and various other modifications may be implemented within a range not departing from the spirit of the present disclosure.

An object of the present disclosure is to provide a temporary stop detection device, a temporary stop detection system, and a non-transitory computer-readable recording medium recorded with a temporary stop detection program that are capable of reliably detecting a temporary stop position.

A first aspect of the present disclosure is a temporary stop detection device that includes: a memory; and a processor coupled to the memory, the processor being configured to: acquire image information indicating a captured image captured by an imaging device provided to a vehicle; detect a plurality of road signs, including a temporary stop sign, from the acquired image information; and detect a temporary stop position by using a bounding box surrounding a region including the plurality of detected road signs.

According to an aspect of the present disclosure, the image information expressing a captured image captured by the imaging device provided to the vehicle is acquired.

Plural road signs including a temporary stop sign are detected based on the acquired image information.

A temporary stop position is detected by employing the bounding box surrounding a region including the plural detected road signs. Detecting the temporary stop position by employing the bounding box including the plural road signs in this manner enables the temporary stop position to be reliably detected, even in cases in which a stop line or a pedestrian crossing is hidden by a vehicle ahead or the like, or if the paint of a road display has peeled away due to age, and so on.

A second aspect of the present disclosure is the temporary stop detection device of the first aspect, wherein the processor is configured to detect a temporary stop position by using a trained model that has learned a temporary stop position as an image region including the plurality of road signs. This enables the temporary stop position to be detected by multidimensional determination based on the plural road signs.

A third aspect of the present disclosure is the temporary stop detection device of the first or second aspect, wherein the processor is configured to detect a position of a base of the bounding box as a temporary stop position. This enables the temporary stop position to be detected, even in cases in which a stop line is hidden by a vehicle ahead or the like, or if the paint of the stop line has peeled away due to age, and so on.

A fourth aspect of the present disclosure is the temporary stop detection device of any of the first to third aspects, wherein the processor is configured to: acquire vehicle information indicating a vehicle speed; estimate a distance to the detected temporary stop position based on the acquired image information; and detect a missed temporary stop at the detected temporary stop position based on a detection result, the acquired vehicle information, and the estimated distance to the temporary stop position. This enables the temporary stop position to be detected, and a missed temporary stop to be reliably detected, even in cases in which a stop line or a pedestrian crossing is hidden by a vehicle ahead or the like, or if the paint of a road display has peeled away due to age, and so on.

A fifth aspect of the present disclosure is the temporary stop detection device of the fourth aspect, wherein the processor is configured to: detect a missed temporary stop in a case in which the estimated distance to the temporary stop position is within a predetermined distance and a temporary stop sign has been detected, and a vehicle speed, serving as the vehicle information, is a predetermined speed or greater while within the predetermined distance. Since the temporary stop position is detected from an image, the temporary stop position is hidden by an ego vehicle and no longer detected immediately prior to actually reaching the temporary stop position. Detecting the vehicle speed when the distance to the temporary stop position is within the predetermined distance in such a manner enables detection of a missed temporary stop at the temporary stop position.

A sixth aspect of the present disclosure is the temporary stop detection device of the fifth aspect, wherein at least one of the predetermined distance or the predetermined speed is set according to at least one of by an individual driver or by an individual vehicle type. This enables a missed temporary stop to be detected according to least one out of by user sensation or by characteristics of individual vehicle type.

A seventh aspect of the present disclosure is the temporary stop detection device of the fourth aspect, wherein the processor is further configured to: determine that a temporary stop line has been passed in a case in which an approach is estimated to have come within a predetermined first distance of a temporary stop position and the approach is estimated to have come within a second distance of the temporary stop position, the second distance being shorter than the first distance; and detect a missed temporary stop in a case in which a temporary stop sign is detected within the first distance and the vehicle speed is a predetermined speed or greater within the first distance. Moreover, a missed temporary stop is detected in cases in which a temporary stop sign is detected within the first distance and the vehicle speed is a predetermined speed or greater when within the first distance. This enables the passage of a temporary stop position, and a missed temporary stop at the temporary stop position, to be detected.

A eighth aspect of the present disclosure is the temporary stop detection device of the seventh aspect, wherein the first distance and the second distance, or the predetermined speed, or a combination thereof, is set according to at least one of by an individual driver or by an individual vehicle type. This enables a missed temporary stop to be detected according to at least one out of by user sensation or by characteristics of individual vehicle type.

A ninth aspect of the present disclosure may be a temporary stop detection system that includes: a temporary stop detection device, including: a memory; and a processor coupled to the memory, the processor being configured to: acquire image information indicating a captured image captured by an imaging device provided to a vehicle, detect a plurality of road signs, including a temporary stop sign, from the acquired image information, and detect a temporary stop position by using a bounding box surrounding a region including the plurality of detected road signs; and an onboard device that is installed at the vehicle provided with the imaging device.

A tenth aspect of the present disclosure may be a non-transitory computer readable recording medium recorded with a temporary stop detection program executable by a computer to perform temporary stop detection processing. The processing includes: acquiring image information indicating a captured image captured by an imaging device provided to a vehicle; detecting a plurality of road signs, including a temporary stop sign, from the acquired image information; and detecting a temporary stop position by using a bounding box surrounding a region including the plurality of detected road signs.

The present disclosure provides a temporary stop detection device, a temporary stop detection system, and a non-transitory computer-readable recording medium recorded with a temporary stop detection program that are capable of reliably detecting a temporary stop position.

What is claimed is:

1. A temporary stop detection device comprising:
a memory; and
a processor coupled to the memory, the processor being configured to:
acquire image information indicating a captured image captured by an imaging device provided to a vehicle;
detect a plurality of road signs, including a temporary stop sign, from the acquired image information; and
detect a temporary stop position by using a bounding box surrounding a region including the plurality of detected road signs.

2. The temporary stop detection device of claim 1, wherein the processor is configured to detect a temporary stop position by using a trained model that has learned a temporary stop position as an image region including the plurality of road signs.

3. The temporary stop detection device of claim 1, wherein the processor is configured to detect a position of a base of the bounding box as a temporary stop position.

4. The temporary stop detection device of claim 1, wherein the processor is configured to:
acquire vehicle information indicating a vehicle speed;
estimate a distance to the detected temporary stop position based on the acquired image information; and
detect a missed temporary stop at the detected temporary stop position based on a detection result, the acquired vehicle information, and the estimated distance to the temporary stop position.

5. The temporary stop detection device of claim 4, wherein the processor is configured to:
detect a missed temporary stop in a case in which the estimated distance to the temporary stop position is within a predetermined distance and a temporary stop sign has been detected, and a vehicle speed, serving as the vehicle information, is a predetermined speed or greater while within the predetermined distance.

6. The temporary stop detection device of claim 5, wherein at least one of the predetermined distance or the predetermined speed is set according to at least one of by an individual driver or by an individual vehicle type.

7. The temporary stop detection device of claim 4, wherein the processor is further configured to:
determine that a temporary stop line has been passed in a case in which an approach is estimated to have come within a predetermined first distance of a temporary stop position and the approach is estimated to have come within a second distance of the temporary stop position, the second distance being shorter than the first distance; and
detect a missed temporary stop in a case in which a temporary stop sign is detected within the first distance and the vehicle speed is a predetermined speed or greater within the first distance.

8. The temporary stop detection device of claim 7, wherein the first distance and the second distance, or the predetermined speed, or a combination thereof, is set according to at least one of by an individual driver or by an individual vehicle type.

9. A temporary stop detection system comprising:
a temporary stop detection device, including
a memory; and
a processor coupled to the memory, the processor being configured to:
acquire image information indicating a captured image captured by an imaging device provided to a vehicle,
detect a plurality of road signs, including a temporary stop sign, from the acquired image information, and
detect a temporary stop position by using a bounding box surrounding a region including the plurality of detected road signs; and
an onboard device that is installed at the vehicle provided with the imaging device.

10. The temporary stop detection system of claim 9, wherein the processor is configured to detect a temporary stop position by using a trained model that has learned a temporary stop position as an image region including the plurality of road signs.

11. The temporary stop detection system of claim 9, wherein the processor is configured to detect a position of a base of the bounding box as a temporary stop position.

12. A non-transitory computer readable recording medium recorded with a temporary stop detection program executable by a computer to perform temporary stop detection processing, the processing comprising:
acquiring image information indicating a captured image captured by an imaging device provided to a vehicle;
detecting a plurality of road signs, including a temporary stop sign, from the acquired image information; and
detecting a temporary stop position by using a bounding box surrounding a region including the plurality of detected road signs.

13. The non-transitory computer readable recording medium of claim 12, wherein the temporary stop detection processing further comprising detecting a temporary stop position by using a trained model that has learned a temporary stop position as an image region including the plurality of road signs.

14. The non-transitory computer readable recording medium claim 12, wherein the temporary stop detection processing further comprising detecting a position of a base of the bounding box as a temporary stop position.
